(19) United States
(12) Patent Application Publication
(10) Pub. No.: US 2008/0046231 A1
(43) Pub. Date: Feb. 21, 2008

(54) System and Method of Language Translation

(75) Inventors: Sondrah S. Laden, Prospect, KY (US); Russ G. Coleman, Louisville, KY (US)

Correspondence Address: MIDDLETON & REUTLINGER, 2500 BROWN & WILLIAMSON TOWER, LOUISVILLE, KY, 40202, US

(73) Assignee: SRK Ventures, LLC, Louisville, KY (US)

(21) Appl. No.: 11/753,925

(22) Filed: May 25, 2007

Related U.S. Application Data
(60) Provisional application No. 60/808,644, filed on May 26, 2006.

(51) Int. Cl. G06F 17/20

(52) U.S. Cl. 704/8

(57) ABSTRACT

A system and method for multilingual communication utilizes a client computer to construct messages in a first language from a plurality of message templates. The message templates may include content that is specifically tailored to address a topic or topics relevant to the type of communication desired. A user constructs a message by selecting templates and associated variables, then send the message to a recipient user. The recipient user selects a language in which to view the message whereupon a corresponding template in the recipient's language is matched to the sender's template to provide a translated message.

### CROSS REFERENCE TO RELATED APPLICATIONS

This application claims priority to and benefit from copending U.S. Provisional Patent Application Ser. No. 60/808,644 of Laden et al. entitled “System and Method for Message Translation”, filed May 26, 2006.

### BACKGROUND OF THE INVENTION

### Field of the Invention

The present invention relates generally to systems and methods of language translation and, more specifically, to a computer-based system of translation from a first language to a second language that utilizes message templates that are completed by users to provide translations from a plurality of languages to a plurality of languages as specified by the individual users.

In the modern age of international business and travel there are often large immigrant populations living in a given country at any time. Often, many people are unfamiliar with the spoken and written language in their new country and have difficulty communicating with others, particularly when they are newly arrived. As an example, many non-English speaking people are living and working in the United States for an extended period of time and must accomplish many day-to-day interactions with others who don't speak their language.

Non-English speaking inhabitants experience problems for which they require solutions from English-only speakers. These problems are often relatively simple to address, but the language barrier prevents effective communication from taking place to the detriment of all. As an example, a non-English speaker may need to communicate with an apartment rental agency or housing authority in a metropolitan area, but lack the communications tools to do so.

There are available prior art conventional language translation programs that will translate documents from one language to another. Such programs are often expensive, complex and difficult to use. Additionally, many prior art language translation programs provide translation of text utilizing stand-alone computers (such as conventional personal computers) that require large memory storage capacities. Many of these conventional programs provide inherently inaccurate translations from one language into another due to difficulty in recognizing idiomatic language usage and the inherent peculiarities of phrasing from language to language. Furthermore, such systems require each user to have the entire translation software package available to them. In a situation where it would be simple and effective to conduct such communications electronically, for example utilizing e-mail messages or the like, many of these prior art translation systems are unwieldy at best.

Additionally, the prior art does include some network based translation systems. However, these systems utilize conventional language translation software with their inherent drawbacks as discussed herein above.

Accordingly, there is a need in the art for a language translation system and method that provides multiple computer users the ability to communicate effectively and cost efficiently, while providing each user the ability to compose and send messages in a language of their choice and a recipient user the ability to read and reply to these messages in a language of their choice.

### SUMMARY OF THE INVENTION

The present invention obviates the deficiencies of the prior art by providing a system and method of language translation that utilizes a client-server computer hardware model to provide a plurality of computer users with a set of message templates that may be readily customized to convey information about a plurality of relevant topics according to their needs and in a selectable language of their choice.

The present invention also provides a system and method of language translation that will generate translations of entire messages of predetermined information and which will allow the recipient to respond in kind in the language of their choice.

The present invention further provides a system and method of language translation at a relatively low cost and that operates with a relatively small amount of computer resources.

The present system for translating messages includes an executable computer program for use in a client computer, for example a personal computer or a central server computer, and further includes a plurality of predetermined message templates in a plurality of communication categories. Furthermore, the executable computer program may operate in the environment of a central server, such as a web server, whereby client computers interface with the server to initiate and conduct message translation. In one embodiment of the invention, the templates begin with a may begin with a generalized question for a user to determine the subject matter of their desired message. One template logically leads to another as a user answers various questions by inserting or selecting from a plurality of message variables included in the template.

Once the series of variables is selected or determined to produce a final message template, it is communicated from the client computer of a first user to a second or recipient user via an electronic communications network which may be part of a broad computer network. A server computer may be provided to execute a translation of the message template which is transmitted through the server to a recipient's client computer. The translated message template may be assembled in the form of an e-mail or similar electronic communication for ease of transmission between the parties, or may simply remain in template form.

The initiating user may select a preferred first language for the first set of message templates so that the message text and the variables that the user selects to complete the message template are in a language of their choosing. In one embodiment of the invention, at a point during the processing, whether at the initiating client computer, the server, or a receiving client computer, the message template is analyzed and matched with a corresponding translated message template in a second language specified by the recipient. These corresponding templates may be used to assemble an e-mail or other electronic message document in the second language which is presented for the recipient. The template-based translation system obviates the need for word-by-word and phrase-by-phrase translation since the templates are already translated and available for use in a plurality of languages.

Accordingly, the present invention provides a system wherein a message in a first language is created from specific questions (queries) asked and answered by a first user in the first language and is transmitted to a recipient. This message is then coordinated or matched with corresponding templates in a second language to formulate a corresponding message that is an accurate translation of the message from the first language to the second language.

The system and method of the present invention includes providing a first, generalized template set for use by a first language speaker to answer preliminary questions. Each preliminary question template is associated with other templates that provide a more detailed message structure based on the variables selected therein. This process continues until the message structure is complete. The message may then be converted to a simple e-mail which is then transmitted over the network (for example the internet) to a second client computer. The second client computer, for example, is equipped to coordinate like templates in a second language and provide a reconstruction of the email in the second language. The final step is displaying the email in the second language for the recipient. In one embodiment of the invention, the server includes the translation software and receives messages in a first language, translates them in a second language, and sends them to their intended recipient.

One advantage of the present system is that it is simple enough to enable the translation computer software to be resident in either the client computers or a central server, depending upon the desired application, since the message templates constructed are essentially pre-translated. That is to say that only any variables entered by a user need to be translated since the overall message template is already known in a plurality of predetermined languages.

The present invention additionally provides a system that includes message templates in a wide variety of subject categories and may be readily customized to be implemented in a plurality of specific communication scenarios. As one example, in a housing or apartment rental setting a group of users may be provided access to a plurality of client computers to communicate with a metropolitan area housing authority, apartment manager, rental management agency or the like. The users may speak many different languages while the manager is an English speaker. The invention can provide a plurality of message templates to address the topics that tenants normally need to address.

As one example, a user may select an initial template that pertains to apartment availability, a maintenance request, a rental contract, electrical and phone service, or any of a variety of initial templates in a language of their choosing. Once the initial template is selected it is displayed to the user via a graphical user interface, typically in the form of a dialog box or window, whereupon the user is prompted to “fill in the details” by either selecting from a drop down menu provided or by manually entering variables in the message template such as dates, times, names, places etc. Once complete, the message template can be transmitted to the manager, who can read it in a language of her choosing by simply selecting the language into which she wishes the message template to be translated. It can be readily seen that the foregoing system may be implemented in a broad array of common communication situations across a spectrum of different types of transactions.

Furthermore, the present invention may also provide a system for producing and translating message templates to produce printed communications in a plurality of languages. Once a message template is complete, a user simply specifies into which languages they wish the message to be translated and printed. This feature of the invention makes it quite simple to produce a message, for example a message about a pool party in an apartment complex, in several different languages for different tenants.

Other features and advantages of the present invention will become apparent from the Detailed Description of the Preferred Embodiments included herein below read in conjunction with the attached Drawing Figures.

### BRIEF DESCRIPTION OF THE DRAWING FIGURES

FIG. 1 is a block diagram of a system and method of language translation in accordance with one embodiment of the present invention.

FIG. 2 is a block diagram of a system and method of language translation in accordance with one embodiment of the present invention.

FIG. 3 is a block diagram of a system and method of language translation in accordance with one embodiment of the present invention.

FIG. 4 is a block diagram of a system and method of language translation in accordance with one embodiment of the present invention.

FIG. 5 is a block diagram of a system and method of language translation in accordance with one embodiment of the present invention.

FIG. 6 is a block diagram of a system and method of language translation in accordance with one embodiment of the present invention wherein a user produces a message in a plurality of languages.

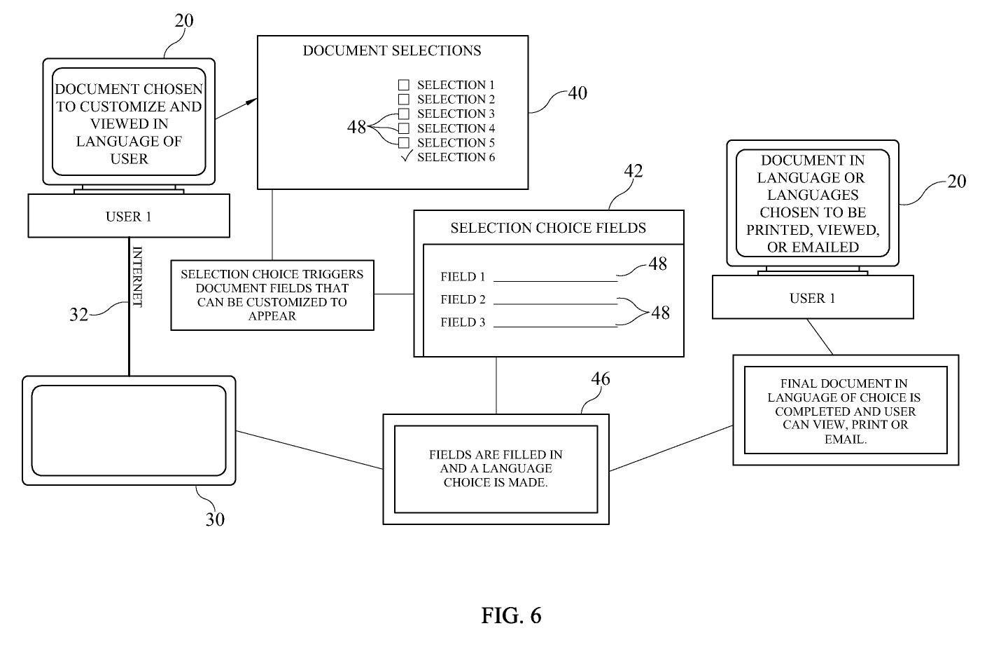

FIG. 7 is an exemplary view of a computer screen depicting a message template used in the system and method of language translation in accordance with one embodiment of the present invention.

FIG. 8 is an exemplary view of a computer screen depicting a message template used in the system and method of language translation in accordance with one embodiment of the present invention.

FIG. 9 is an exemplary view of a computer screen depicting a plurality of message templates that may be selected in the system and method of language translation in accordance with one embodiment of the present invention.

FIG. 10 is an exemplary view of a computer screen depicting a reply message template used in the system and method of language translation in accordance with one embodiment of the present invention.

FIG. 11 is an exemplary view of a computer screen depicting a message template for producing a document that may be selected in the system and method of language translation in accordance with one embodiment of the present invention.

FIG. 12 is an exemplary view of a computer screen depicting a message template for producing a document that may be selected in the system and method of language translation in accordance with one embodiment of the present invention.

### DETAILED DESCRIPTION OF THE PREFERRED EMBODIMENT(S)

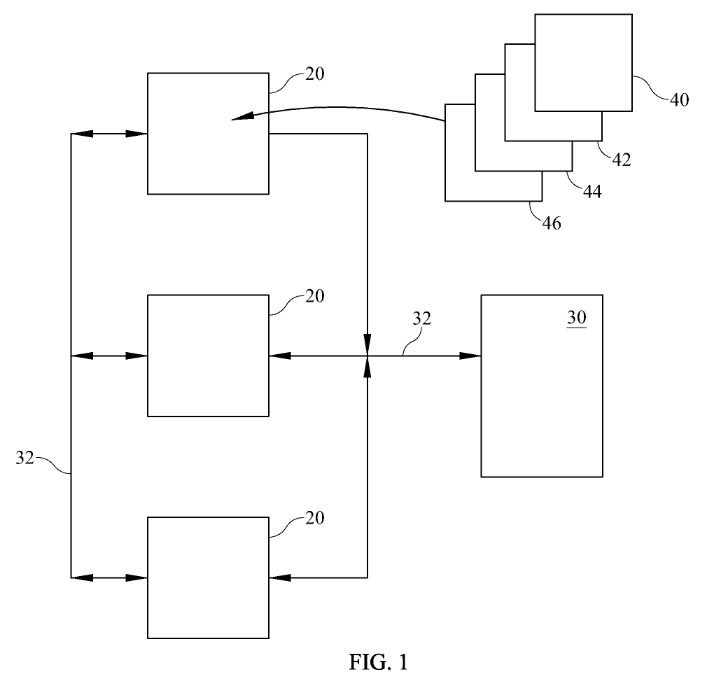

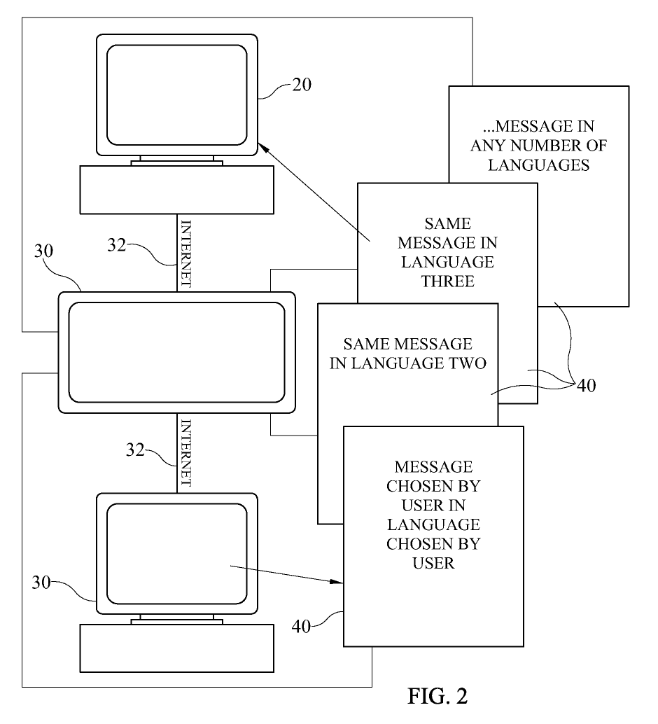

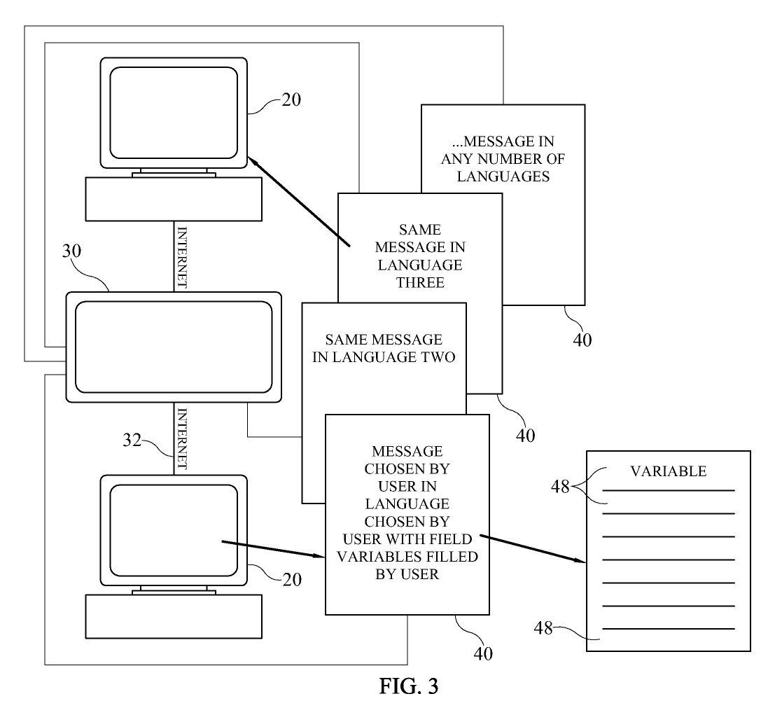

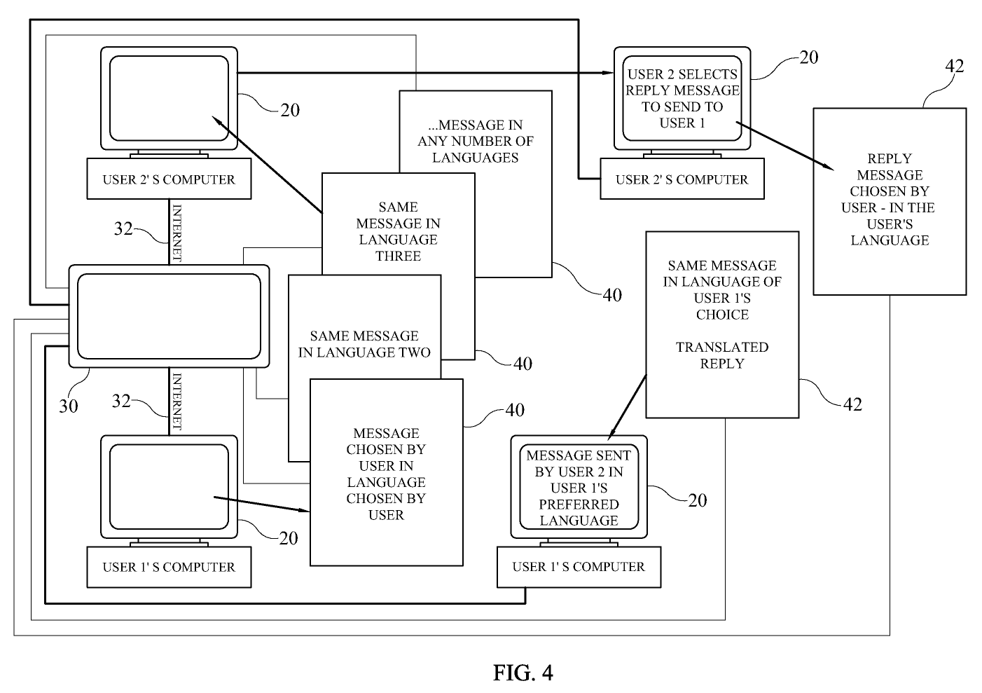

Referring now to drawing FIGS. 1-4, and in accordance with one embodiment of the present invention, a system and method of language translation 10 includes a plurality of client computers 20 which may comprise a conventional personal computer having an associated microprocessor and data memory, and further including a monitor and graphical user interface as is known in the art. While the client computers 20 may be conventional personal computers as are known in the art, the invention is not limited to the use of personal computers for its operation. Indeed client computer 20 may be any computer suitable for executing program instructions and storing data.

The invention may further comprise at least one server computer 30 which is physically remote from the client computers 20. Server 30 communicates electronically with the plurality of clients 20 via known communications network 32 protocols. While it is contemplated that server 30 communicates with clients 20 via, for example an internet communications protocol, other communications protocols may be employed in the system of the present invention without departing from the scope thereof.

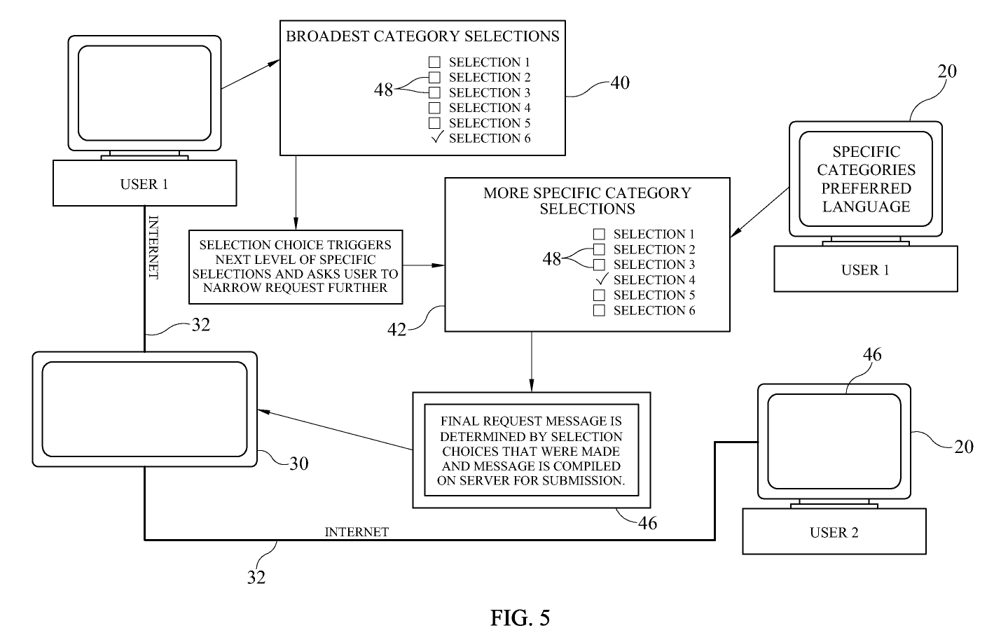

The present invention may include a suitable software instruction set resident on the client computers 20 or server 30 that generates a plurality of message templates 40, 42, 44, 46 that may be viewed by a user. As best seen in FIG. 5, templates may comprise a first, general message template 40 and thereafter more detailed or specific message templates 42-46. While for purposes of the present example three message templates 42, 44 and 46 have been referenced, there is no limit to the number of message templates 40-46 which may be employed to produce a detailed and specific message. The use of a plurality of templates in drawing FIG. 5 is for illustrative purposes only.

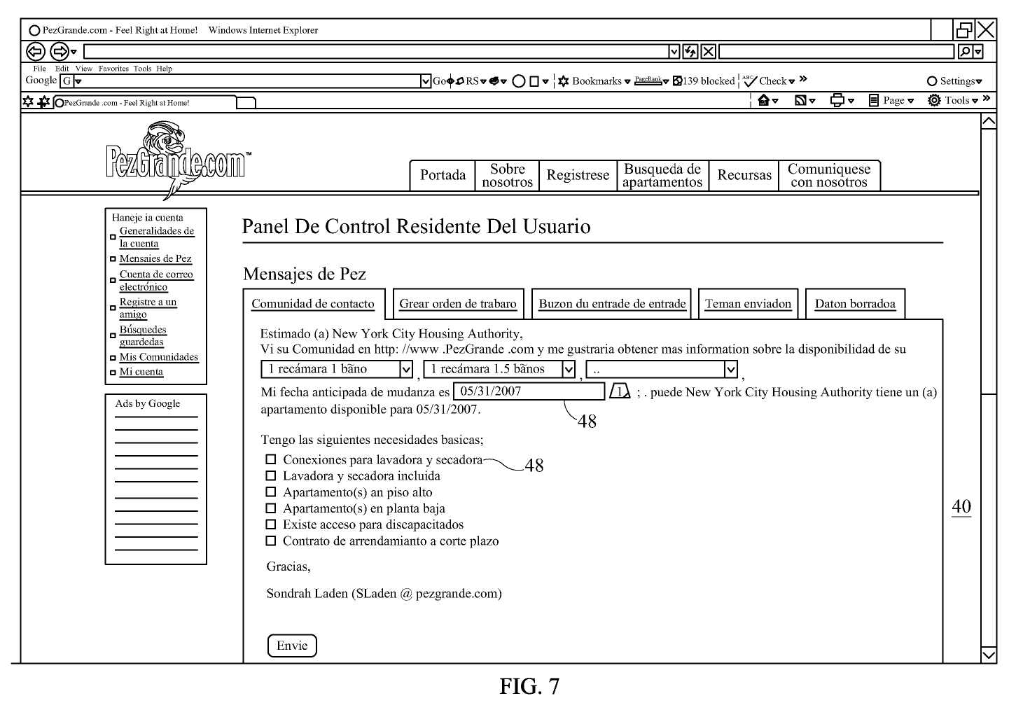

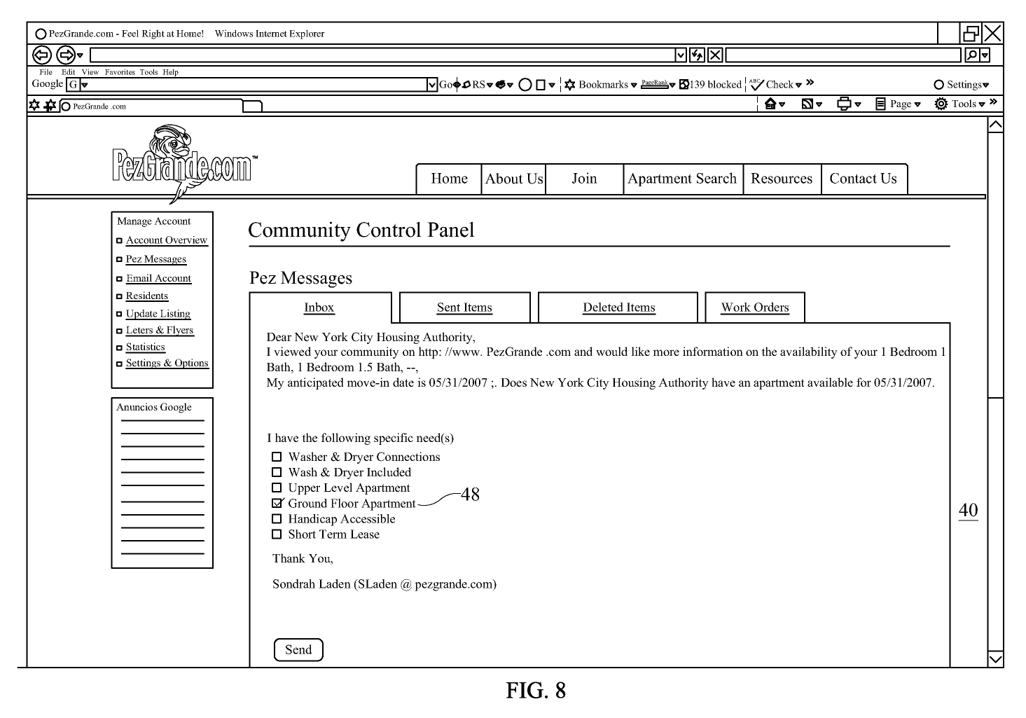

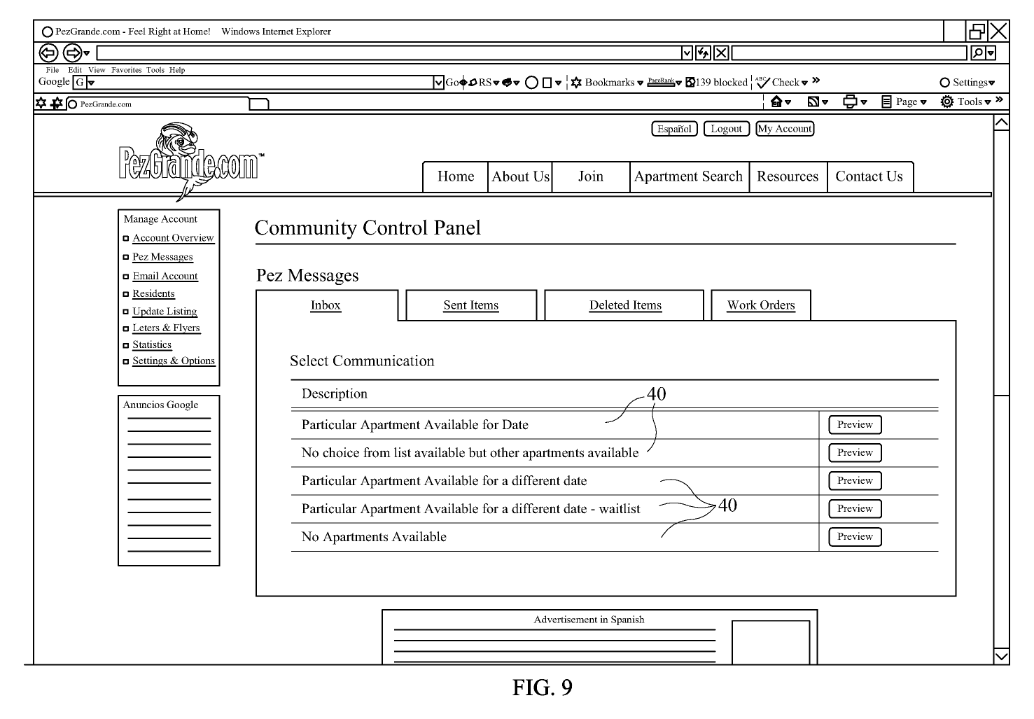

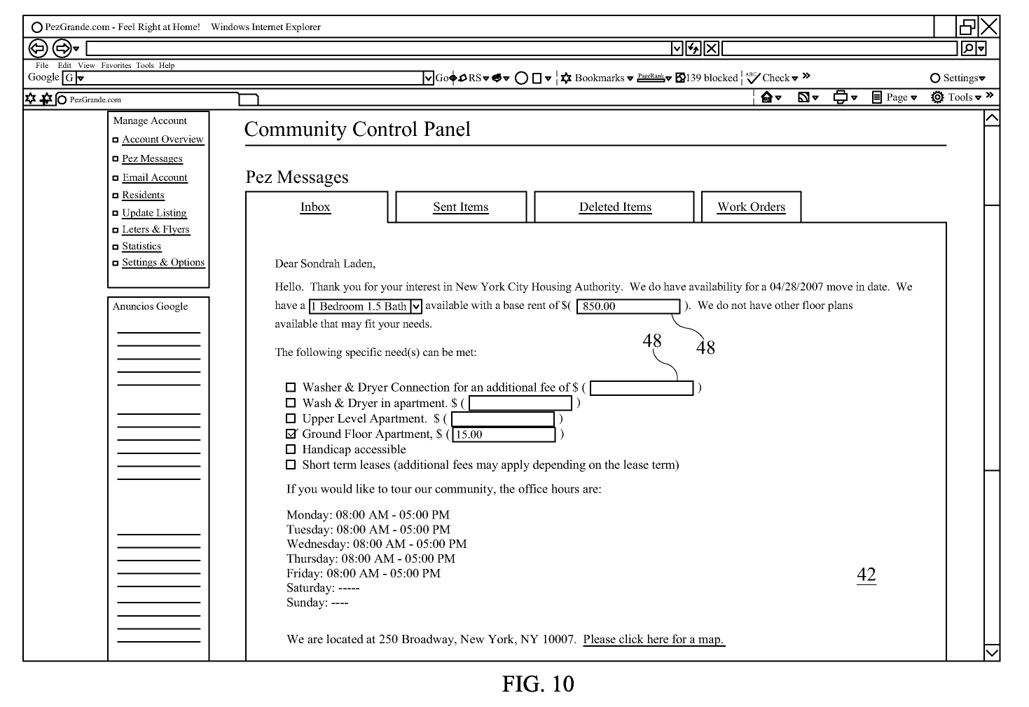

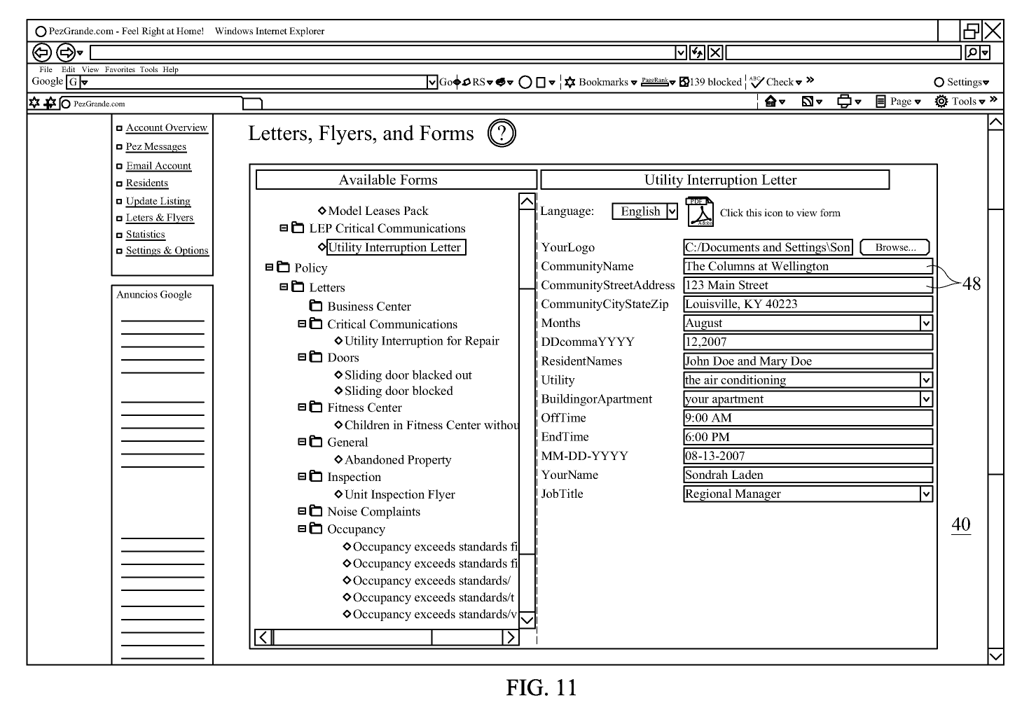

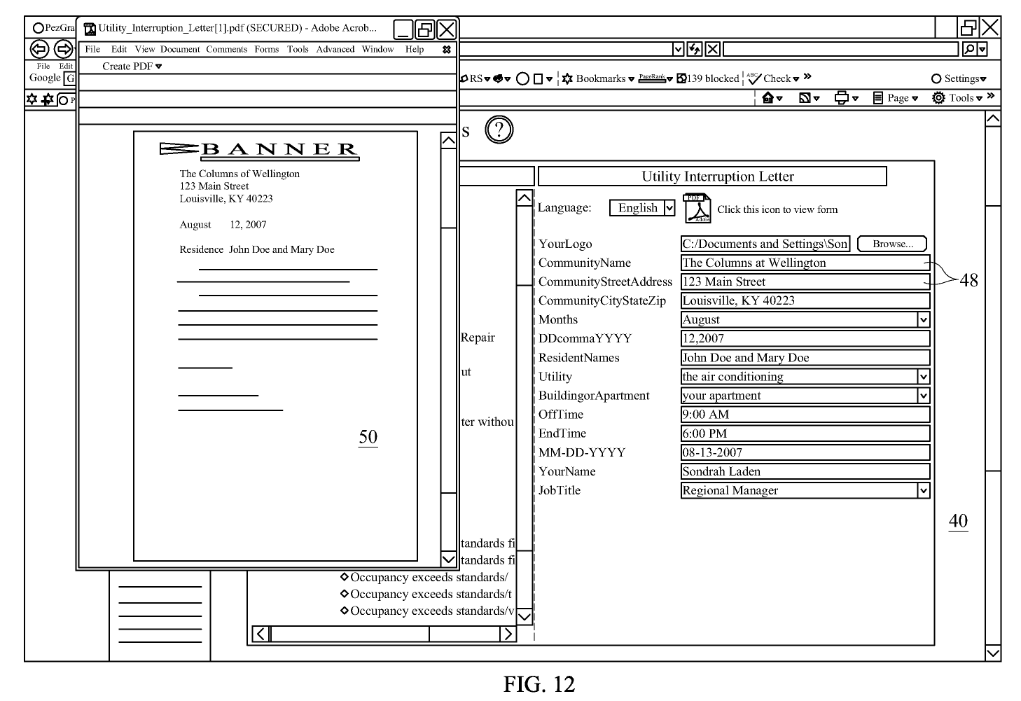

Message templates 40 may include specific written communications common to a business activity, hobby, sport, or any other topic that may then be selected and customized by a user to create a specific communication in a language of their choice. Typically these message templates 40 may be selected and viewed using a plurality of windows and drop down menus commonly utilized to enable user interaction with computer software programs. The user may specify a language in which to view a message template 40 and thus in which to compose a message. The language selection may be accomplished by simply selecting a language of choice via a drop down menu, as best seen in FIGS. 11 and 12. When a first message template 40 is selected, the user may be prompted to select a second, more content specific message template 42 that more accurately addresses the user's communication concern, or a third message template 44, until the user has selected the message template that most accurately states the message. In this fashion, the user sequentially selects a plurality of message templates 40 to configure the content of the message being contemplated. Exemplary message and reply templates 40 are depicted in FIGS. 7-10.

Furthermore, message templates 40-46 may include a plurality of variable fields 48 therein that may be completed by a user to customize template 40. The variable fields may be completed by selecting items from drop down menus, by typing appropriate text in a blank variable field such as a dialog box or other spaces provided on message templates 40-46, or by selecting items from a list of items displayed in templates 40-46. An example of a template 40 having a plurality of message variables 48 for user selection is best seen in FIGS. 5 and 7. A user may also be prompted to select a more specific template 42 depending upon the initial template 40 selection to complete message composition.

Generally, variables 48 may be provided for insertion in message templates 40 in a plurality of defined categories. Multiple choice variables 48 are those that are simply selected from a list or drop-down menu by a user. Multiple choice variables are translated in advance such that once a user selects a variable 48 in a message template 40 in a first language, that variable is already translated into a plurality of other languages in corresponding message templates 40. Universal variables 48 are those that don't ordinarily require any translation such as numerals or dollar amounts. Additionally, subjective variables 48 are included where a field or dialog box may be filled out to insert a user's name, address, specific instructions, or other information not included in the templates 40-46 and their concomitant variables 48.

Variables 48 may include any items, terms or phrases germane to message template 40 that a user may need to customize for effective communication. For example, in the context of a request to view an apartment, variables may include the number of bedrooms, number of bathrooms, the floor on which the apartment is located, a desired availability date, desired location, or any other information a user or recipient may find helpful in constructing the request. The use of message template 40 enables an identical message to be quickly assembled in a recipient user's language of choice since message templates 40 are provided in a plurality of languages. Thus only the variable 48 portions of the message need be translated into the recipient user's language then inserted into their identical positions message template 40 to provide an accurate, fast and reliable language to language translation and communication system.

When a first user desires to send a message to a second user, the invention enables the first user to select a desired operational language, select from among a plurality of message templates 40 to choose a desired message subject, thence customize the message by choosing variables 48. The first user then sends the message to a desired recipient, for example by selecting a “send” or “submit” button with a mouse or other operator interface, whereupon the message is transmitted electronically via server 30.

The second (or recipient) user may also select a desired language in which to view, send and receive messages. Generally speaking, the translation system 10 of the present invention matches the message template 40 in the first language with a corresponding message template 40 in the second language, translates variables 48 from the first language into the second language (where necessary), then populates the template 40 in the second language with the translated variables. Thus a message in constructed in the second user's language without the reliance on complex translation algorithms and their concomitant disadvantages.

It should be understood that the translation system 10 can be completed either in a client computer 20 or the server 30, or a combination thereof without departing from the scope of the present invention. For example, in one embodiment of the invention, a first user composes and submits a message on their client computer 20 utilizing message templates 40 and variables 48 stored in the data memory thereof. The message is transmitted through server 30 to the second user's client computer 20. The second user's client computer 20 then matches template 40 in the first user's language of choice (or template 42 etc.) with a corresponding template in the second user's language of choice to construct the message in the second language. Client computer 20 then translates variables 48 into the second user's language, populates the variable 48 fields in template 40 with the translated variables, then displays the translated message to the second user.

In an alternative embodiment of the invention, the matching of first language message template 40 with corresponding second language message template 40 and translation of variable 48 may take place in translation server 30 rather than in either client computer 20. In this embodiment of the invention, the client computers 20 are used to assemble message templates 40 and submit them to server 30 for translation and transmission to a recipient user.

In a yet further embodiment of the invention, client computers 20 are used to communicate with translation server 30 that includes all templates 40, variables 48 and translation software. This client-server arrangement can use conventional TCPIP communications protocols to enable a plurality of user to send and receive messages, each in their own language, by selecting and configuring the requisite templates 40 as discussed hereinabove. In this embodiment of the invention, user may operate interact with conventional web-browser software resident on client computers 20 to communicate with translation server 30. As can be readily seen from the above examples, the present invention may be practiced by providing suitable template matching software at a plurality of locations.

In an alternative embodiment of the instant invention a first user may utilize the system 10 to construct an email from a completed template 40-46 for transmission across the internet in the manner of any other email. The recipient user client computer 20 may be suitably programmed to receive the email, recognize the template 40 or templates used to construct the e-mail, coordinate the replacement of the template 40 in a first language to a template 40 in a second language, and finally assemble an e-mail message having a structure similar to the structure originally presented in the first language. In this example, the format of the client to client communication is modified, whereas the template to template translation remains intact.

In a yet further embodiment of the present invention, a system 10 may be provided for use in an in-house network having its own dedicated server 30. This embodiment of the invention may be particularly useful where a business, school or the like employs multiple locations with users speaking a plurality of different languages since a plurality of templates 40-46 can be assembled to present the users with a wide variety of customizable messages from which to choose, and which are commonly used in a particular business, social or educational setting. As can be seen from the prior operation examples, the present invention is not reliant on whether the matching of the message templates 40-46 occurs in a client computer 20 or a server 30 or other computer provided to operate the translation and template software.

In a yet further alternative embodiment of the present invention, the system 10 and method described herein can readily produce electronic documents 50, for example documents capable of being viewed in common word processing or web-browsing programs, in a plurality of languages which may then be printed for dissemination, faxed, either using hardcopy or electronically, or communicated by any of a plurality of methods to their intended recipients. FIGS. 11 and 12 depict exemplary computer screen views of a template 40 having a plurality of selectable variables 48 to customize a document 50. In this embodiment of the invention a user simply selects a desired template 40 that most accurately matches the type of message desired from a plurality thereof, completes any associated variable 48 fields, and submits the completed template 40 to be saved as a document in any one of a plurality of languages by the template 40 matching process described hereinabove. Once the specific language message templates 40 have been produced, the invention may convert the templates to conventional electronic files, for example text or document files, so that they may be readily reproduced through the use of conventional word processing software or the like. The user simply specifies which languages he or she wishes message to be produced in utilizing a window menu selection, rather than submit the message to a specific user. The document or documents produced may then be printed and mailed, attached to e-mails as electronic copies, or faxed to any intended recipients.

It should be understood that the present system 10 and method has a broad array of operational uses and is not limited by the specific examples provided in the instant specification. The system 10 may be employed wherever two people speaking different languages wish to communicate effectively. Furthermore, by customizing the plurality of templates available to an individual user, the present system 10 may be configured to operate in specific transactional environments.

As an example of the invention configured for use in a specific transactional environment, assume a first Spanish speaking user, who is an apartment renter experiencing problems with their unit's hot water heater. The second (or recipient user) is an English speaking apartment manager. The first user accesses a client computer 20 (which may be provided in an apartment common area) and initiates operation of the translation program by, for example, selecting a start icon. The client computer 20 present an initial screen having a plurality of templates 40 from which to choose as well as a language selection menu, permitting the user to select their operational language of choice. The first user chooses a template 40 that identifies a maintenance problem in an apartment. A second template 42 may then appear on screen to query whether hot water is available or whether there is a leak. A third template 44 may then query whether the water has been shut off to the heater or other detailed questions, as well as permit the user to input their apartment number, location etc. Alternatively, these queries may simply form a part of the initial template 40 that may be selected or checked using the operator interface of client computer 20.

Once the problem is completely described using the templates provided, the first user can select a “submit” icon to enable message transmission of the information in the templates in a first language understood by the user. The display of such a message to the first user may be optional. The program identifies the templates 40-46 used and assembles a corresponding message template in a second language, in the present case English, which is transmitted to the apartment manager for appropriate corrective action. Optionally, the apartment manager may choose response templates 40 to schedule a convenient time for repairs, which response templates 40 are created in English, then translated to Spanish upon transmission.

As is readily seen from the foregoing example, the present invention provides a database coordination program in which templates in a first language are matched with corresponding templates in a second language to produce similar messages in both languages. It is understood that there are several variations on the way the program may be implemented. For example, the matching of templates 40 in a second (or third, or fourth) language may take place in any client 20 or server 30 without departing from the scope of the invention. Further, the message constructed by the first or initiating user may never actually be assembled in the first language but rather the templates 40 are used to directly assemble the message in the second language.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

We claim:

1. A method of multilingual communication between a plurality of client computer users, each of said client computers having a user interface and communicating with each other over a communications network comprising the steps of:
providing a language choice selection to a first user to select a first language;
providing a plurality of message templates in said first language to said first user to select a message template to transmit to a second user;
providing a language choice selection to a second user to select a second language; and
translating said message template from said first language to a message template in said second language to be viewed by said second user.

2. A method of multilingual communication as claimed in claim 1 wherein the step of translating said message template from said first language to said second language comprises:
matching said message template in said first language with a corresponding message template in said second language for viewing by said second user.

3. A method of multilingual communication as claimed in claim 2 further comprising;
transmitting said translated message template to said second user.

4. A method of multilingual communication as claimed in claim 1 wherein said plurality of message templates comprise a plurality of application specific messages.

5. A method of multilingual communications as claimed in claim 1 wherein said plurality of message templates comprise a plurality of queries to be answered by said first user to configure said message template.

6. A method of multilingual communication as claimed in claim 1 wherein the selection of a message template by a first user comprises:
sequentially selecting a plurality of message templates to configure message content.

7. A method of multilingual communication as claimed in claim 1 wherein said plurality of message templates comprise a plurality of variables selectable by said users.

8. A method of multilingual communications as claimed in claim 7 wherein said plurality of variables comprises a plurality of text selections for configuring the content of said message template.

9. A method of multilingual communications as claimed in claim 7 wherein said plurality of variables comprise a blank field to be completed by a user.

10. A method of multilingual communications as claimed in claim 7 comprising the further step of:
selecting at least one variable in each of said plurality of message templates to configure message content.

11. A method of multilingual communications as claimed in claim 7 wherein said variables comprise:
universal variables;
subjective variables; and
multiple choice variables.

12. A method of multilingual communication as claimed in claim 7 wherein the step of translating said message template to said second language comprises:
matching said message template in said first language with a corresponding message template in said second language; and
translating said variable fields from said first language to said second language.

13. A method of multilingual communication as claimed in claim 12 wherein the step of translating said message template to said second language comprises:
inserting said variable fields in said second language into said variable fields in said second language template.

14. A method of multilingual communications as claimed in claim 1 wherein said step of translating said message template from said first language to a message template in said second language is performed in said first user's client computer.

15. A method of multilingual communications as claimed in claim 1 wherein said step of translating said message template from said first language to a message template in said second language is performed in said second user's client computer.

16. A method multilingual communication as claimed in claim 1 further comprising the steps of:
providing a plurality of message reply templates to said second user to select a reply message in said second language; and
translating said reply message template in said second language to a reply message template in a first language to be viewed by said first user.

17. A method of multilingual communication as claimed in claim 16 where said reply message templates provided to said second user comprise logically related responses to said message template provided by said first user.

18. A method of multilingual communication as claimed in claim 1 wherein said plurality of message templates comprise:
a plurality of pre-translated messages germane to common communication topics in a specific field of endeavor.

19. A method of multilingual communication as claimed in claim 16 wherein said plurality of message reply templates comprise:
a plurality of pre-translated messages germane to common communication topics in a specific field of endeavor.

20. A method of multilingual communication as claimed in claim 1 comprising the step of:
providing a translation server communicating with said client computers wherein the step of translating said message template into said second language is completed in said translation server.

21. A method of multilingual communication as claimed in claim 1 comprising the step of:
providing a web server communicating with said plurality of client computers; and
wherein the step of translating said message template into said second language is completed in said web server.

22. A method of multilingual communication as claimed in claim 1 further comprising the step of:
converting said translated message template into an e-mail communication to said second user.

23. A method of multilingual communication between at least one client computer user and a plurality of recipients comprising the steps of:
providing a language choice selection to said user to select a first language in which said user wishes to compose said message;
providing a plurality of message templates in said first language to said user to select a message template to communicate to said recipients;
providing a plurality of translated message language choices for said user to select a plurality of languages into which said message template is translated; and
translating said message template from said first language to a plurality of message templates in said plurality of chosen languages to be viewed by said recipients.

24. A method of multilingual communication between at least one client computer user and a plurality of recipients as claimed in claim 23 further comprising:
converting said plurality of message templates in said plurality of chosen languages into an electronic file format for viewing and reproduction on said at least one client computer.

25. A method of multilingual communication between at least one client computer user and a plurality of recipients as claimed in claim 23 further comprising:
providing a plurality of variable selections for each of said message templates to enable said user to customize the content of said message.

26. A method of multilingual communication between at least one client computer user and a plurality of recipients as claimed in claim 23 wherein said variable selections comprise:
universal variables;
subjective variables; and
multiple choice variables.

27. A method of multilingual communications between at least one client computer user and a plurality of recipients as claimed in claim 23 comprising the further steps of:
providing a plurality of document types selectable by said user; and
producing said document types in said plurality of languages selected by said user

28. A multilingual communication system comprising:
a plurality of client computers each including a plurality of user configurable message templates stored therein;
said client computers in electronic communication with each other via a communications network; and
wherein said message templates are provided in a plurality of languages wherein a user may select a language of choice.

29. A multilingual communication system as claimed in claim 28 further comprising:
a plurality of user-configurable variables in each of said message templates, said variables corresponding to message specific topical content for customizing said message templates.

30. A multilingual communication system as claimed in claim 29 wherein said variables comprise:
universal variables;
multiple choice variables; and
subjective variables.

31. A multilingual communication system as claimed in claim 28 further comprising:
a plurality of reply message templates logically interrelated to said message templates provided in a plurality of languages wherein a user may select a language of choice.

32. A multilingual communication system as claimed in claim 28 further comprising:
a translation server communicating with said client computers through a communications network wherein said the matching and translation of message templates from a first language into other languages takes place in said translation server.
